(19) United States
(12) Patent Application Publication
(10) Pub. No.: US 2014/0329118 A1
(43) Pub. Date: Nov. 6, 2014

(54) ALL SOLID STATE BATTERY

(71) Applicants: Hiroshi Nagase, Mishima-shi (JP); Takamasa Ohtomo, Susono-shi (JP)

(72) Inventors: Hiroshi Nagase, Mishima-shi (JP); Takamasa Ohtomo, Susono-shi (JP)

(73) Assignee: TOYOTA JIDOSHA KABUSHIKI KAISHA, Toyota-shi, Aichi (JP)

(21) Appl. No.: 14/360,843

(22) PCT Filed: Dec. 6, 2011
(86) PCT No.: PCT/JP2011/078205

§ 371 Date: May 27, 2014

(51) Int. Cl. H01M 10/0585; H01M 4/133; H01M 4/131; H01M 10/04; H01M 10/0525

(52) U.S. Cl. CPC H01M 10/0585; H01M 10/0436; H01M 10/0525; H01M 4/131; H01M 4/133
USPC 429/66

(57) ABSTRACT

Disclosed is an all solid state battery that includes a cathode layer containing a cathode active material, an anode layer containing an anode active material, and a solid electrolyte layer formed between the cathode layer and the anode layer, wherein the anode layer contains the anode active material such that a carbon-based active material and a metal-based active material are mixed, the metal-based active material is a metal represented by a general formula M or a metal oxide represented by a general formula MₓO_{y} (M is a metal) for causing an alloying reaction with Li, a charge and discharge potential of the metal-based active material is nobler than that of the carbon-based active material, and a capacity ratio of the carbon-based active material in the anode layer is higher than that of the metal-based active material.

### TECHNICAL FIELD

The present invention relates to an all solid state battery having self-restraining force and capable of downsizing external restraint.

### BACKGROUND ART

In accordance with a rapid spread of information relevant apparatuses and communication apparatuses such as a personal computer, a video camera and a portable telephone in recent years, the development of a battery to be utilized as a power source thereof has been emphasized. The development of a high-output and high-capacity battery for an electric automobile and a hybrid automobile has been advanced also in the automobile industry, and the development of a lithium battery with a high energy density has been advanced.

A material containing Si or Sn with a high theoretical capacity has been researched as an anode active material in such a lithium battery for coping with a higher capacity of a battery. However, in the case of using an anode active material containing Si or Sn, volume change due to expansion and contraction of the active material caused during an insertion elimination reaction of lithium is large.

In Patent Literature 1, an all solid state battery having a sulfide solid electrolyte as an electrolyte material and having a structure of inhibiting the all solid state battery from upsizing and improving energy density is disclosed.

### CITATION LIST

### Patent Literature

Patent Literature 1: Japanese Patent Application Publication (JP-A) No. 2011-124084

### SUMMARY OF INVENTION

### Technical Problem

However, the all solid state battery of Patent Literature 1 is used while restrained under external pressure; expansion and contraction due to insertion elimination of lithium are not considered, and external restraint needs to be increased in the case where volume expansion is large, so that the problem is that the further downsizing of a lithium battery is difficult.

The present invention has been made in view of the above-mentioned actual circumstances, and the object thereof is to provide an all solid state battery having self-restraining force and capable of downsizing external restraint.

### Solution to Problem

To solve the above-mentioned problem, the present invention provides an all solid state battery comprising a cathode layer containing a cathode active material, an anode layer containing an anode active material, and a solid electrolyte layer formed between the above-mentioned cathode layer and the above-mentioned anode layer, characterized in that the above-mentioned anode layer contains the anode active material such that a carbon-based active material and a metal-based active material are mixed, the above-mentioned metal-based active material is a metal represented by a general formula M or a metal oxide represented by a general formula MₓO_{y} (M is a metal) for causing an alloying reaction with Li, a charge and discharge potential of the above-mentioned metal-based active material is nobler than a charge and discharge potential of the above-mentioned carbon-based active material, and a capacity ratio of the above-mentioned carbon-based active material in the above-mentioned anode layer is higher than a capacity ratio of the above-mentioned metal-based active material.

According to the present invention, the metal-based active material has so nobler electric potential than the carbon-based active material that an insertion reaction of a lithium ion is caused prior to the carbon-based active material at the initial stage of charge, and expansion of volume is caused to allow self-restraining force to be applied inside the anode layer. Thus, the metal-based active material exists while expanding also in charge thereafter (after the initial stage of charge), so that a lithium ion is inserted into the carbon-based active material while self-restraining force is always applied inside the anode layer. Accordingly, external restraint may be downsized. In addition, according to the present invention, a volume ratio of the carbon-based active material in the anode layer is so higher than that of the metal-based active material that the carbon-based active material functions as a cushioning material for relieving stress caused during expansion of the above-mentioned metal-based active material, and allows the anode layer to be inhibited from expanding.

In the above-mentioned invention, a capacity ratio of the above-mentioned metal-based active material in the above-mentioned anode layer is preferably the lowest capacity ratio or less of a battery using range (an SOC range). The reason therefor is that a capacity ratio of the metal-based active material is determined at the lowest capacity ratio or less of a battery using range (occasionally referred to simply as an SOC range hereinafter), so that the metal-based active material into which a lithium ion is inserted may be used as a member which does not contribute to a charge and discharge reaction and allows self-restraining force. That is to say, a lithium ion is inserted into the metal-based active material in the first charge reaction, and a volume ratio of the metal-based active material is the lowest volume ratio (such as SOC of 20%) or less of an SOC range, so that the metal-based active material into which a lithium ion is inserted does not contribute to a charge and discharge reaction in a charge and discharge reaction thereafter (such as SOC of 20% to 80%).

On the other hand, in an SOC range, the metal-based active material exists while volume is expanding, so as to allow self-restraining force to be always applied inside the anode layer. As a result, input-output characteristics and cycling characteristics are improved.

### BRIEF DESCRIPTION OF DRAWINGS

FIG. 1 is a schematic cross-sectional view showing an example of an all solid state battery of the present invention.

FIGS. 2A and 2B are graphs showing potential change with respect to capacity fraction of an anode active material obtained in Example 1 and Comparative Examples 1 and 2.

FIGS. 3A and 3B are graphs showing a result of capacity maintenance factor during high rate of an anode active material obtained in Example 2 and Comparative Example 3.

FIG. 4 is a graph showing a result of capacity maintenance factor after cycle under low external restraint of an anode active material obtained in Example 2 and Comparative Examples 3 and 4.

### DESCRIPTION OF EMBODIMENTS

An all solid state battery of the present invention is hereinafter described in detail.

A. All Solid State Battery

First, an all solid state battery of the present invention is described. The all solid state battery of the present invention is an all solid state battery comprising a cathode layer containing a cathode active material, an anode layer containing an anode active material, and a solid electrolyte layer formed between the above-mentioned cathode layer and the above-mentioned anode layer, characterized in that the above-mentioned anode layer contains the anode active material such that a carbon-based active material and a metal-based active material are mixed, the above-mentioned metal-based active material is a metal represented by a general formula M or a metal oxide represented by a general formula MₓO_{y} (M is a metal) for causing an alloying reaction with Li, a charge and discharge potential of the above-mentioned metal-based active material is nobler than a charge and discharge potential of the above-mentioned carbon-based active material, and a capacity ratio of the above-mentioned carbon-based active material in the above-mentioned anode layer is higher than a capacity ratio of the above-mentioned metal-based active material.

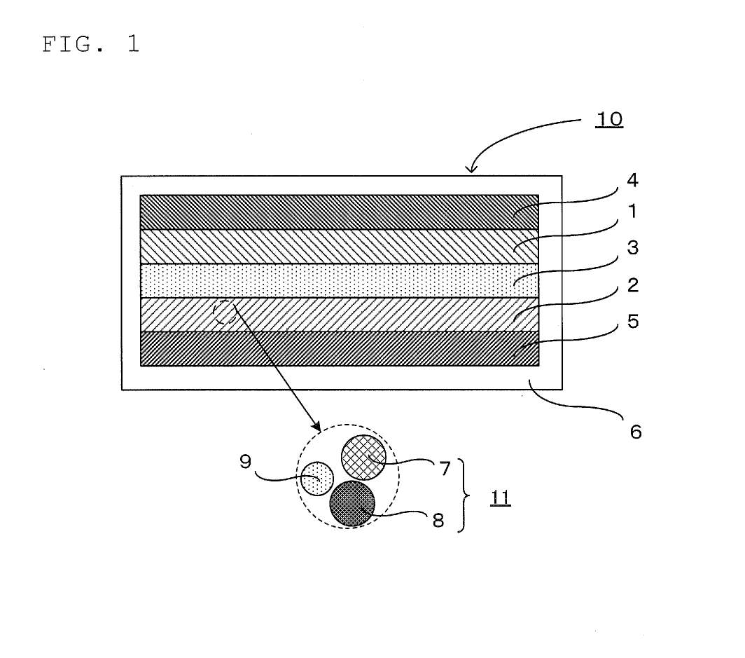

FIG. 1 is a schematic cross-sectional view showing an example of the all solid state battery of the present invention. An all solid state battery 10 exemplified in FIG. 1 comprises a cathode layer 1, an anode layer 2, a solid electrolyte layer 3 formed between the cathode layer 1 and the anode layer 2, a cathode current collector 4 for collecting the cathode layer 1, an anode current collector 5 for collecting the anode layer 2, and a battery case 6 for storing these members. Also, the anode layer 2 has an anode active material 11 comprising a carbon-based active material 7 and a metal-based active material 8, and a sulfide solid electrolyte material 9. Here, “all solid state battery” of the present invention signifies a member containing at least a power generating element composed of the cathode layer 1, the anode layer 2, and the solid electrolyte layer 3. Thus, the all solid state battery of the present invention may be only the power generating element, or such as to have the power generating element as well as the cathode current collector, the anode current collector and the battery case, as shown in FIG. 1.

According to the present invention, the metal-based active material has so nobler electric potential than the carbon-based active material that an insertion reaction of a lithium ion is caused prior to the carbon-based active material at the initial stage of charge, and expansion of volume is caused to allow self-restraining force to be applied inside the anode layer. Thus, the metal-based active material exists while expanding also in charge thereafter (after the initial stage of charge), so that a lithium ion is inserted into the carbon-based active material while self-restraining force is always applied inside the anode layer. Accordingly, external restraint may be downsized. In addition, according to the present invention, a volume ratio of the carbon-based active material in the anode layer is so higher than that of the metal-based active material that the carbon-based active material functions as a cushioning material for relieving stress caused during expansion of the above-mentioned metal-based active material, and allows the anode layer to be inhibited from expanding.

Also, the metal-based active material has a characteristic such as to be high in theoretical capacity as compared with the carbon-based active material and be large in expansion and contraction in accordance with charge and discharge, whereas the carbon-based active material has a characteristic such as to be small in volume expansion coefficient and be inferior in theoretical capacity to the metal-based active material. According to the present invention, the use of the metal-based active material and the carbon-based active material by combination allows the all solid state battery having high capacity and capable of inhibiting volume expansion. In addition, the carbon-based active material tends to be so small in irreversible capacity during the first charge as compared with the metal-based active material that a capacity ratio of the carbon-based active material in the anode layer is made higher than that of the metal-based active material, whereby the all solid state battery with smaller irreversible capacity may be obtained.

The all solid state battery of the present invention is hereinafter described in each constitution.

1. Anode Layer

The anode layer in the present invention is a layer containing an anode active material such that a carbon-based active material and a metal-based active material are mixed.

(1) Anode Active Material

The anode active material in the present invention is such that a carbon-based active material and a metal-based active material are mixed, and charge and discharge are performed by insertion and elimination of a lithium ion in each of the active materials.

Each constitution of the anode active material is hereinafter described.

(i) Metal-Based Active Material

The metal-based active material in the present invention is a metal represented by a general formula M or a metal oxide represented by a general formula MₓO_{y} (M is a metal) for causing an alloying reaction with Li, and a charge and discharge potential thereof is nobler than that of the carbon-based active material. Here, the alloying reaction signifies a reaction such that the metal oxide or the metal reacts with a metal ion such as an Li ion to change into a lithium alloy.

The above-mentioned metal-based active material is nobler in a charge and discharge potential (an insertion and elimination potential of a lithium ion) than the carbon-based active material. Accordingly, an insertion elimination reaction of a lithium ion into the metal-based active material precedes an insertion elimination reaction of a lithium ion into the carbon-based active material. Thus, the metal-based active material expands in volume, but the above-mentioned expansion is inhibited so moderately by the after-mentioned carbon-based active material as to allow self-restraining force to be effectively applied inside the anode layer.

Incidentally, it may be confirmed, for example, by measuring in a cyclic voltammetry method that the above-mentioned metal-based active material is nobler in a charge and discharge potential than the above-mentioned carbon-based active material.

Also, the metal-based active material is preferably higher in theoretical capacity than the carbon-based active material. The reason therefor is to allow the capacity of the all solid state battery to be improved.

The metal or the metal oxide used for the metal-based active material in the present invention is represented by a general formula of M or a general formula of MₓO_{y} (M is a metal), respectively. In the above-mentioned general formulae, M is preferably Bi, Sb, Sn, Si, Al, Pb, In, Mg, Ti, Zr, V, Fe, Cr, Cu, Co, Mn, Ni, Zn, Nb, Ru, Mo, Sr, Y, Ta, W or Ag; among them, in the present invention, Al, Si and Sn are more preferable, and Al is far more preferable.

The reason therefor is that Al is comparatively large in electric capacity, an alloy of Al and lithium is inexpensive and high in performance, and has a large plateau region at an electric potential during insertion and elimination of a lithium ion, and most of the capacity occurs at a nobler electric potential than a reaction of graphite.

Also, the metal oxide in the present invention is preferably SiO, SnO and the like. Incidentally, in the present invention, M may contain two kinds or more of metals.

Examples of the shape of the metal-based active material in the present invention include a particulate shape such as a perfectly spherical shape and an elliptically spherical shape, a needle shape, and a thin-film shape, preferably a particulate shape, above all. The average particle diameter (D₅₀) of the metal-based active material is, for example, preferably within a range of 5 nm to 50 μm, and more preferably within a range of 50 nm to 5 μm.

(ii) Carbon-Based Active Material

A capacity ratio of the carbon-based active material in the present invention in the anode layer is higher than that of the above-mentioned metal-based active material, and charge and discharge are performed by an insertion elimination reaction of a lithium ion. Also, the carbon-based active material has the function of moderately inhibiting expansion as a cushioning material when the metal-based active material expands in volume due to an insertion reaction of a lithium ion.

Kinds of the carbon-based active material in the present invention are preferably such as to have softness for moderately relieving stress caused during expansion and contraction of the metal-based active material; examples thereof include natural graphite (graphite) and improved bodies, artificial graphite (such as MCMB), hard-graphitized material (hard carbon) and easy-graphitized material (soft carbon), and graphite is preferably used among them. The reason therefor is that it is high in crystallinity and comparatively high in theoretical capacity.

Also, the carbon-based active material in the present invention is preferably lower in volume expansion coefficient than the metal-based active material. The reason therefor is that it may downsize external restraint more easily.

Examples of the shape of the carbon-based active material in the present invention include a particulate shape such as a perfectly spherical shape and an elliptically spherical shape, and a thin-film shape, preferably a particulate shape, above all. Also, in the case where the carbon-based active material is in a particulate shape, the average particle diameter thereof is preferably within a range of 0.1 μm to 100 μm, and more preferably within a range of 1 μm to 50 μm.

The reason therefor is that too large particle diameter of the carbon-based active material brings a possibility that resistance increases in a contact part with the after-mentioned solid electrolyte material, whereas too small particle diameter of the carbon-based active material brings a possibility that the particle diameter becomes smaller than the solid electrolyte material to produce the carbon-based active material with scarce conduction of a lithium ion.

The anode layer in the present invention contains the carbon-based active material and the metal-based active material. The mass ratio of both varies with factors such as specific gravity and maximum capacity of a lithium ion, and is not particularly limited. Above all, the metal-based active material is preferably within a range of 0.1 part by mass to 200 parts by mass, more preferably within a range of 1 part by mass to 100 parts by mass, and far more preferably within a range of 5 parts by mass to 50 parts by mass with respect to 100 parts by mass of the carbon-based active material.

The reason therefor is that too high content of the metal-based active material brings a possibility that the carbon-based active material may not inhibit volume expansion of the metal-based active material. On the other hand, the reason therefor is that too low content of the metal-based active material brings a possibility that the relative ratio of the metal-based active material decreases and the capacity of the carbon-based active material is so small as compared with the metal-based active material as not to improve the capacity of the anode layer.

(iii) Anode Active Material

(a) Capacity Ratio

The present invention is characterized in that a capacity ratio of the carbon-based active material in the anode layer is ordinarily higher than a capacity ratio of the metal-based active material.

The capacity ratio of the carbon-based active material to the total capacity of the carbon-based active material and the metal-based active material is, for example, preferably within a range of 50% to 95%, and more preferably within a range of 70% to 95%.

On the other hand, the capacity ratio of the metal-based active material to the total capacity of the carbon-based active material and the metal-based active material is, for example, preferably within a range of 5% to 50%, and more preferably within a range of 5% to 30%.

Also, the difference between the capacity ratio of the carbon-based active material and the capacity ratio of the metal-based active material to the total capacity of the carbon-based active material and the metal-based active material is, for example, preferably 10% or more, and more preferably within a range of 10% to 45%.

In addition, a capacity ratio of the metal-based active material in the anode layer is preferably the lowest capacity ratio or less of an SOC range. The reason therefor is that a capacity ratio of the metal-based active material is determined at the lowest capacity ratio or less of a battery using range (an SOC range), so that the metal-based active material into which a lithium ion is inserted may be used as a member which does not contribute to a charge and discharge reaction and allows self-restraining force. That is to say, a lithium ion is inserted into the metal-based active material in the first charge reaction, and a volume ratio of the metal-based active material is the lowest volume ratio (such as SOC of 20%) or less of an SOC range, so that the metal-based active material into which a lithium ion is inserted does not contribute to a charge and discharge reaction in a charge and discharge reaction thereafter (such as SOC of 20% to 80%). On the other hand, in an SOC range, the metal-based active material exists while volume is expanding, so as to allow self-restraining force to be always applied inside the anode layer. As a result, input-output characteristics and cycling characteristics are improved.

Here, a relation between an SOC range of the all solid state battery and a capacity ratio of the anode active material contained in the above-mentioned all solid state battery is described. Ordinarily, an SOC range as a capacity range to be used is determined and the all solid state battery is used while controlled within the range. For example, a car-mounted battery is variously determined at an SOC range of 20% to 80%, an SOC range of 10% to 80%, and an SOC range of 20% to 90%. For example, the all solid state battery determined at an SOC range of 20% to 80% signifies an actual use in a battery capacity range of 20% to 80%. The all solid state battery of the present invention may be used in an SOC range of 5% or more, an SOC range of 10% or more, or an SOC range of 20% or more, for example.

Also, a capacity ratio of the contained anode active material is preferably adjusted in accordance with particularly the lowest capacity ratio of an SOC range determined in the all solid state battery to be used. For example, in the case of the all solid state battery determined at an SOC range of 20% or more, a capacity ratio of the metal-based active material in the anode layer is preferably within a range of 10% to 20%, and more preferably within a range of 10% to 18%.

(b) Others

The content of the anode active material in the anode layer in the present invention is not particularly limited but is, for example, preferably within a range of 1% by mass to 50% by mass, and more preferably within a range of 5% by mass to 10% by mass.

The case where the content is lower than the above-mentioned range brings a possibility that the amount of the anode active material for performing insertion and elimination of a lithium ion is so small as to decrease volume capacity. On the other hand, the case where the content is higher than the above-mentioned range brings a possibility that ion conductivity deteriorates and input and output decrease.

(2) Solid Electrolyte Material

The anode layer in the present invention preferably contains a solid electrolyte material. The reason therefor is that the addition of the solid electrolyte material allows ion conductivity in the anode layer to be improved. In the present invention, self-restraining force is applied inside the anode layer, so that the contact of the above-mentioned anode active material and the solid electrolyte material becomes favorable. That is to say, input-output and cycling characteristics may be improved.

The solid electrolyte material in the present invention is not particularly limited if the material is such as to have lithium ion conductivity, but examples thereof include inorganic solid electrolyte materials such as a sulfide solid electrolyte material, an oxide base solid electrolyte material, a nitride solid electrolyte material, and a halide solid electrolyte material; in the present invention, a sulfide solid electrolyte material and an oxide base solid electrolyte material are preferably used, and a sulfide solid electrolyte material is used particularly preferably. The sulfide solid electrolyte material is preferable in view of being high in ion conductivity, and the oxide base solid electrolyte material is preferable in view of being high in chemical stability. Incidentally, the halide solid electrolyte material signifies an inorganic solid electrolyte material containing halogen.

The sulfide solid electrolyte material ordinarily contains at least lithium element (Li) and sulfur (S). In particular, the sulfide solid electrolyte material preferably contains Li, A (A is at least one kind selected from the group consisting of P, Si, Ge, Al and B) and S. Also, the sulfide solid electrolyte material may contain halogen such as Cl, Br and I. The inclusion of halogen allows ion conductivity to be improved. Also, the sulfide solid electrolyte material may contain O. The inclusion of O allows chemical stability to be improved.

Examples of the sulfide solid electrolyte material include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (“m” and “n” are positive numbers; Z is any of Ge, Zn and Ga), Li₂S—GeS₂, Li₂S—SiS₂—Li₃PO₄, and Li₂S—SiS₂—LiₓMO_{y} (“x” and “y” are positive numbers; M is any of P, Si, Ge, B, Al, Ga and In). Incidentally, the description of the above-mentioned “Li₂S—P₂S₅” signifies the sulfide solid electrolyte material obtained by using a raw material composition containing Li₂S and P₂S₅, and other descriptions signify similarly.

Also, in the case where the sulfide solid electrolyte material is obtained by using a raw material composition containing Li₂S and P₂S₅, the ratio of Li₂S to the total of Li₂S and P₂S₅ is, for example, preferably within a range of 70 mol % to 80 mol %, more preferably within a range of 72 mol % to 78 mol %, and far more preferably within a range of 74 mol % to 76 mol %. The reason therefor is to allow the sulfide solid electrolyte material having an ortho-composition or a composition in the neighborhood of it and allow the sulfide solid electrolyte material with high chemical stability. Here, ortho generally signifies oxo acid which is the highest in degree of hydration among oxo acids obtained by hydrating the same oxide. In the present invention, a crystal composition to which Li₂S is added most among sulfides is called an ortho-composition. Li₃PS₄ corresponds to the ortho-composition in the Li₂S—P₂S₅ system. In the case of an Li₂S—P₂S₅-based sulfide solid electrolyte material, the ratio of Li₂S and P₂S₅ such as to allow the ortho-composition is Li₂S:P₂S₅=75:25 on a molar basis. Incidentally, also in the case of using Al₂S₃ and B₂S₃ instead of P₂S₅ in the above-mentioned raw material composition, the preferable range is the same. Li₃AlS₃ corresponds to the ortho-composition in the Li₂S—Al₂S₃ system and Li₃BS₃ corresponds to the ortho-composition in the Li₂S—B₂S₃ system.

Also, in the case where the sulfide solid electrolyte material is obtained by using a raw material composition containing Li₂S and SiS₂, the ratio of Li₂S to the total of Li₂S and SiS₂ is, for example, preferably within a range of 60 mol % to 72 mol %, more preferably within a range of 62 mol % to 70 mol %, and far more preferably within a range of 64 mol % to 68 mol %. The reason therefor is that it may allow the sulfide solid electrolyte material having an ortho-composition or a composition in the neighborhood of it and allow the sulfide solid electrolyte material with high chemical stability. Li₄SiS₄ corresponds to the ortho-composition in the Li₂S—SiS₂ system. In the case of an Li₂S—SiS₂-based sulfide solid electrolyte material, the ratio of Li₂S and SiS₂ such as to allow the ortho-composition is Li₂S:SiS₂=66.7:33.3 on a molar basis. Incidentally, also in the case of using GeS₂ instead of SiS₂ in the above-mentioned raw material composition, the preferable range is the same. Li₄GeS₄ corresponds to the ortho-composition in the Li₂S—GeS₂ system.

Also, in the case where the sulfide solid electrolyte material is obtained by using a raw material composition containing LiX (X=Cl, Br and I), the ratio of LiX is, for example, preferably within a range of 1 mol % to 60 mol %, more preferably within a range of 5 mol % to 50 mol %, and far more preferably within a range of 10 mol % to 40 mol %. Also, in the case where the sulfide solid electrolyte material is obtained by using a raw material composition containing Li₂O, the ratio of Li₂O is, for example, preferably within a range of 1 mol % to 25 mol %, and more preferably within a range of 3 mol % to 15 mol %.

Also, the sulfide solid electrolyte material may be sulfide glass, crystallized sulfide glass, or a crystalline material obtained by a solid phase method. Incidentally, the sulfide glass may be obtained by performing mechanical milling (such as ball mill) for a raw material composition, for example. Also, the crystallized sulfide glass may be obtained by heat-treating the sulfide glass at a temperature of crystallization temperature or higher, for example. Also, the lithium ion conductance at normal temperature of the sulfide solid electrolyte material is, for example, preferably 1×10⁻⁵ S/cm or more, and more preferably 1×10⁻⁴ S/cm or more.

On the other hand, examples of the oxide base solid electrolyte material include a compound having a NASICON type structure. Examples of the compound having a NASICON type structure include a compound represented by a general formula Li₁₊ₓAlₓGe₂₋ₓ(PO₄)₃ (0≦x≦2). Above all, the above-mentioned oxide base solid electrolyte material is preferably Li_{1.5}Al_{0.5}Ge₁₅(PO₄)₃. Also, other examples of the compound having a NASICON type structure include a compound represented by a general formula Li₁₊ₓAlₓTi₂₋ₓ(PO₄)₃ (0≦x≦2). Above all, the above-mentioned oxide base solid electrolyte material is preferably Li_{1.5}Al_{0.5}Ti₁₋₅(PO₄)₃. Also, other examples of the oxide base solid electrolyte material include LiLaTiO (such as Li_{0.34}La_{0.51}TiO₃), LiPON (such as Li_{2.9}PO_{3.3}N_{0.46}) and LiLaZrO (such as Li₇La₃Zr₂O₁₂).

Examples of the shape of the solid electrolyte material in the present invention include a particulate shape and a thin-film shape. The average particle diameter (D₅₀) of the solid electrolyte material is, for example, preferably within a range of 1 nm to 100 μm, and more preferably within a range of 10 nm to 30 μm. Also, the content of the solid electrolyte material in the anode layer is not particularly limited but is, for example, preferably within a range of 10% by mass to 90% by mass.

(3) Anode Layer

The anode layer in the present invention may further contain at least one of a binder and a conductive material as required.

The conductive material is not particularly limited but examples thereof include carbon materials such as mesocarbon microbeads (MCMB), acetylene black, Ketjen Black, carbon black, coke, carbon fiber, vapor-grown carbon, and graphite. Also, examples of the binder include polyimide, polyamideimide and polyacrylic acid.

Also, the thickness of the anode layer in the present invention is, for example, preferably within a range of 0.1 μm to 1000 μm, and more preferably within a range of 1 μm to 100 μm.

A general method may be used as a method for forming the anode layer in the present invention. For example, the anode layer may be formed in such a manner that an anode layer forming paste containing the above-mentioned anode active material, solid electrolyte material, binder and conductive material is applied and dried on the after-mentioned anode current collector, and thereafter pressed.

2. Cathode Layer

The cathode layer in the present invention is a layer containing at least a cathode active material, in which an insertion elimination reaction of a lithium ion is caused and charge and discharge are caused.

(1) Cathode Active Material

Kinds of the cathode active material of the cathode layer in the present invention are properly selected in accordance with kinds of the all solid state battery, and examples thereof include an oxide active material and a sulfide active material. Examples of the cathode active material include bed type cathode active materials such as LiCoO₂, LiNiO₂, LiCo_{1/3}Ni_{1/3}Mn_{1/3}O₂, LiVO₂ and LiCrO₂, spinel type cathode active materials such as LiMn₂O₄, Li (Ni_{0.25}Mn_{0.75})₂O₄, LiCoMnO₄ and Li₂NiMn₃O₈, olivine type cathode active materials such as LiCoPO₄, LiMnPO₄ and LiFePO₄, and NASICON type cathode active materials such as Li₃V₂P₃O₁₂.

Examples of the shape of the above-mentioned cathode active material include a particulate shape and a thin-film shape. The average particle diameter (D₅₀) of the cathode active material is, for example, preferably within a range of 1 nm to 100 μm, and more preferably within a range of 10 nm to 30 μm.

The content of the cathode active material of the cathode layer in the present invention is not particularly limited but is, for example, preferably within a range of 40% by mass to 99% by mass.

(2) Cathode Layer

The cathode layer may contain a solid electrolyte material. The reason therefor is that the inclusion of the solid electrolyte material allows ion conductivity of the cathode layer to be improved while the cathode active material and the solid electrolyte material are contacting. The solid electrolyte material is the same as the contents described in the above-mentioned section “1. Anode layer”; therefore, the description herein is omitted. The content of the solid electrolyte material in the cathode layer is not particularly limited but is, for example, preferably within a range of 10% by mass to 90% by mass.

The cathode layer in the present invention may further contain at least one of a conductive material and a binder, which are the same as the contents described in the above-mentioned section “1. Anode layer”; therefore, the description herein is omitted.

The thickness of the cathode layer is, for example, preferably within a range of 0.1 μm to 1000 and more preferably within a range of 1 μm to 100 μm.

A general method may be used as a method for forming the cathode layer in the present invention. For example, the cathode layer may be formed in such a manner that a cathode layer forming paste containing the cathode active material, solid electrolyte material, binder and conductive material is applied and dried on the after-mentioned cathode current collector, and thereafter pressed.

3. Solid Electrolyte Layer

The solid electrolyte layer in the present invention is described. The solid electrolyte layer in the present invention is a layer formed between the above-mentioned cathode layer and the above-mentioned anode layer, and a layer containing at least the solid electrolyte material. Lithium ion conduction between the cathode active material and the anode active material is performed through the above-mentioned solid electrolyte material.

(1) Solid Electrolyte Material

Examples of the solid electrolyte material in the present invention include inorganic solid electrolyte materials such as a sulfide solid electrolyte material, an oxide base solid electrolyte material, a nitride solid electrolyte material, and a halide solid electrolyte material; above all, the same material as the solid electrolyte material used in the above-mentioned “1. Anode layer” is preferably used. Incidentally, the solid electrolyte material is the same as the contents described in “1. Anode layer”; therefore, the description herein is omitted. Also, the content of the solid electrolyte material contained in the solid electrolyte layer in the present invention is, for example, preferably 60% by mass or more, more preferably 70% by mass or more, and particularly preferably 80% by mass or more.

(2) Solid Electrolyte Layer

The solid electrolyte layer in the present invention may contain a binder, or may be composed of only the solid electrolyte material. The thickness of the solid electrolyte layer varies greatly with constitutions of the all solid state battery, and is, for example, preferably within a range of 0.1 μm to 1000 μm, and above all, preferably within a range of 0.1 μm to 300 μm.

A general method may be used as a method for forming the solid electrolyte layer in the present invention. For example, the solid electrolyte layer may be formed by pressing a solid electrolyte layer forming material containing the solid electrolyte material and the binder.

4. Other Constitutions

The all solid state battery of the present invention comprises at least the above-mentioned cathode layer, anode layer and solid electrolyte layer, and may further comprise a cathode current collector for collecting the cathode layer and an anode current collector for collecting the anode layer. Examples of a material for the cathode current collector include SUS, aluminum, nickel, iron, titanium and carbon. On the other hand, examples of a material for the anode current collector include SUS, copper, nickel and carbon.

Also, the thickness and shape of the cathode current collector and the anode current collector are preferably selected properly in accordance with factors such as uses of the all solid state battery.

A battery case of a general all solid state battery may be used for a battery case in the present invention. Examples of the battery case include a battery case made of SUS.

5. All Solid State Battery

The all solid state battery of the present invention may be a primary battery or a secondary battery, preferably a secondary battery among them. The secondary battery may be repeatedly charged and discharged and is useful as a car-mounted battery, for example. Examples of the shape of the all solid state battery include a coin shape, a laminate shape, a cylindrical shape and a rectangular shape.

A method for producing the all solid state battery of the present invention is not particularly limited if the method is a method for allowing the above-mentioned all solid state battery, but the same method as a method for producing a general all solid state battery may be used; examples thereof include a press method, a coating method, an evaporation method and a spray method. In the case of producing an all solid state battery by using a press method, examples thereof include a method, in which a solid electrolyte layer is first formed by pressing a material composing a solid electrolyte layer, and a material composing a cathode layer is added on one surface of the above-mentioned solid electrolyte layer and pressed together with a cathode current collector to thereby form a cathode layer; next, a material composing an anode layer is added on the other surface of the above-mentioned solid electrolyte layer and pressed together with an anode current collector to thereby form an anode layer, and the periphery of the obtained power generating element is covered with an exterior body to thereby obtain an all solid state battery.

Incidentally, the present invention is not limited to the above-mentioned embodiments. The above-mentioned embodiments are exemplification, and any is included in the technical scope of the present invention if it has substantially the same constitution as the technical idea described in the claim of the present invention and offers similar operation and effect thereto.

### EXAMPLES

The present invention is described more specifically while showing examples and comparative examples hereinafter.

### Synthesis Example

### Synthesis of Sulfide Solid Electrolyte Material

Lithium sulfide (Li₂S, manufactured by NIPPON CHEMICAL INDUSTRIAL CO., LTD.) and phosphorus pentasulfide (P₂S₅, manufactured by Sigma-Aldrich Co. LLC.) were used as a starting material. Next, Li₂S and P₂S₅ were weighed in a glove box under an Ar atmosphere (dew-point temperature: −70° C.) so as to be a molar ratio of 75Li₂S.25P₂S₅ (Li₃PS₄, ortho-composition). Mixed was 2 g of this mixture with an agate mortar for 5 minutes. Thereafter, 2 g of the obtained mixture was projected into a vessel of planetary ball mill (45 cc, made of ZrO₂), 4 g of dehydrated heptane (a moisture amount of 30 ppm or less) was projected thereinto, and 53 g of a ZrO₂ ball (φ=5 mm) was projected thereinto to hermetically seal the vessel completely (Ar atmosphere). This vessel was mounted on a planetary ball mill machine (P7™ manufactured by FRITSCH JAPAN CO, LTD.) to perform mechanical milling at the number of soleplate revolutions of 500 rpm for 40 hours. Thereafter, the obtained test sample was dried on a hot plate so as to remove the heptane to obtain a sulfide solid electrolyte material (75Li₂S.25P₂S₅ glass).

### Example 1

### Preparation of Anode Active Material

Graphite (manufactured by Mitsubishi Chemical Corporation) and Al powder (manufactured by Sigma-Aldrich Co. LLC.) were weighed by 860 mg and 71 mg respectively, and mixed to thereby obtain an anode active material.

Next, the sulfide solid electrolyte material 75Li₂S-25P₂S₅ prepared in Synthesis Example was weighed by 860 mg and mixed with the above-mentioned anode active material to thereby obtain an anode layer forming material.

(Production of Single Electrode Evaluation Battery)

A working layer was formed by using 15 mg of the above-mentioned anode layer forming material on one surface of a solid electrolyte layer formed by using 100 mg of the sulfide solid electrolyte material 75Li₂S.25P₂S₅ prepared in Synthesis Example, and next, a counter electrode was formed by using metal lithium on the other surface of the solid electrolyte layer to produce a single electrode evaluation battery.

### Comparative Example 1

Used was 930 mg of graphite for an anode active material, which was mixed with the sulfide solid electrolyte material prepared in Synthesis Example to obtain an anode layer forming material. A single electrode evaluation battery was obtained by using 17 mg of this anode layer forming material in the same manner as Example 1.

### Comparative Example 2

Used was 930 mg of Al for an anode active material, which was mixed with the sulfide solid electrolyte material prepared in Synthesis Example to obtain an anode layer forming material. A single electrode evaluation battery was obtained by using 6.5 mg of this anode layer forming material in the same manner as Example 1.

### Evaluations 1

### First Irreversible Efficiency

With the use of the single electrode evaluation battery obtained in Example 1, Comparative Examples 1 and 2, constant-current discharge was performed up to a voltage of 0 V at a battery evaluation environmental temperature of 25° C. and a current rate of 0.1 C, and thereafter constant-current charge was performed up to a voltage of 1.5 V at a current rate of 0.1 C. Weight capacity, volume capacity before expansion and first irreversible rate at this time were measured. The results are shown in Table 1.

TABLE 1

| | | | VOLUME | |
|---|---|---|---|---|
| | ANODE | | CAPACITY | FIRST |
| | ACTIVE | WEIGHT | BEFORE | IRREVERSIBLE |
| | MATERIAL | CAPACITY | EXPANSION | RATE |
| EXAMPLE 1 | GRAPHITE + Al | 425 mAh/g | 956 mAh/cc | 6.5% |
| | (Al CAPACITY 20%) | | | |
| COMPARATIVE | GRAPHITE | 372 mAh/g | 818 mAh/cc | 6% |
| EXAMPLE 1 | | | | |
| COMPARATIVE | Al | 993 mAh/g | 2681 mAh/cc | 17% |
| EXAMPLE 2 | | | | |

As shown in Table 1, the working electrode obtained in Example 1 contains Al with so high capacity as to allow weight capacity and volume capacity before expansion to be improved more than Comparative Example 1 composed of only graphite.

Also, the working electrode obtained in Example 1 exhibits so lower a value of the first irreversible rate than the working electrode of Comparative Example 2 composed of only Al as to suggest the value is inhibited up to a value which is almost the same as Comparative Example 1. That is to say, it is conceived that the addition of graphite to Al inhibits expansion and contraction of Al from influencing for the reason that graphite becomes a cushioning material.

### Evaluations 2

### Anode Potential During Battery Discharge

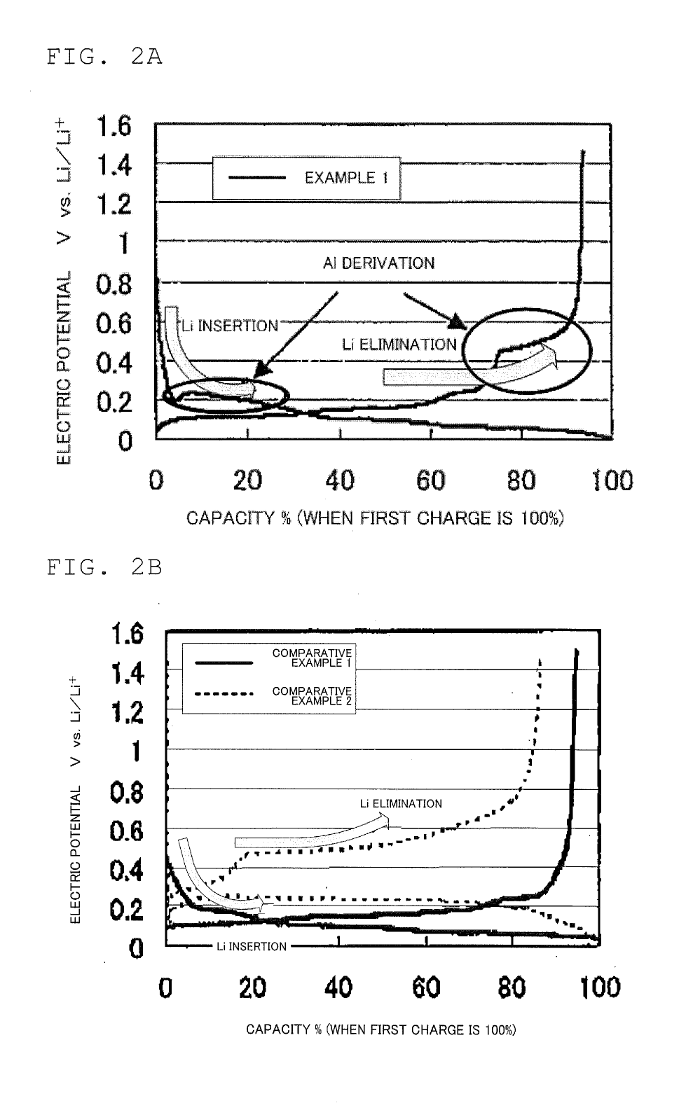

With regard to the single electrode evaluation battery obtained in each of Example 1, Comparative Examples 1 and 2, lithium insertion elimination potential with respect to the whole capacity ratio in the above-mentioned charge and discharge was measured. The result is shown in FIGS. 2A and 2B.

As shown in FIG. 2B, when potential change of Comparative Examples 1 and 2 is compared, Al as the anode active material of Comparative Example 2 is so nobler in the insertion elimination potential of lithium than graphite as the anode active material of Comparative Example 1 that it is suggested that a lithium ion is inserted into Al before graphite during battery charge whereas a lithium ion is eliminated from Al after graphite during battery discharge. As shown in FIG. 2A, in Example 1 containing the anode active material with Al and graphite mixed, the mixture is such that the capacity ratio of Al is an SOC of 20% or less, so that a lithium ion insertion reaction into Al precedes in an SOC of 20% or less, and all Al is filled with a lithium ion and expands in an SOC of 20% or more. That is to say, it is conceived that only a lithium ion insertion elimination reaction of graphite is caused in an SOC of 20% or more. Also, a plateau emerges at 0.5 V vs Li/Li⁺ in the vicinity of an SOC of 80%, so that it is conceived that a lithium ion is eliminated from Al after a lithium ion is eliminated from graphite. That is to say, it is guessed that self-restraining force is applied inside the anode layer by expanding all Al at the initial stage of charge.

### Example 2

### Preparation of Cathode Layer Forming Material

LiNi_{1/3}CO_{1/3}Mn_{1/3}O₂ (manufactured by Nichia Corporation), VGCF (manufactured by Showa Denko K.K.) and 75Li₂S-25P₂S₅ prepared in Synthesis Example were weighed as a cathode active material, a conductive material and a solid electrolyte material by 600 mg, 25.5 mg and 250 mg respectively, and mixed to thereby obtain a cathode layer forming material.

(Production of all Solid State Battery)

The sulfide solid electrolyte material 75Li₂S-25P₂S₅ prepared in Synthesis Example was weighed by 50 mg, put in a metal mold of 1 cm² and pressed at 1 ton/cm² to thereby form a solid electrolyte layer. The above-mentioned cathode layer forming material was added by 19 mg on one surface of the obtained solid electrolyte layer, and pressed at 1 ton/cm² to thereby form a cathode layer. Next, the anode layer forming material prepared in Example 1 was added by 15 mg on the other surface of the solid electrolyte layer, and pressed at 4.3 ton/cm² to thereby form an anode layer and then obtain a power generating element.

An Al foil (manufactured by Nippon Foil Mfg. Co., Ltd.) with a thickness of 15 μm and a Cu foil (manufactured by Nippon Foil Mfg. Co., Ltd.) with a thickness of 10 μm were disposed as a cathode current collector and an anode current collector respectively in the obtained power generating element to obtain an all solid state battery.

Incidentally, an SOC range of the all solid state battery obtained in Example 2 is determined at SOC of 20% to 80%.

### Comparative Example 3

An all solid state battery was obtained in the same manner as Example 2 except for forming an anode layer by using 17 mg of the anode layer forming material prepared in Comparative Example 1 in the production of the all solid state battery of Example 2.

Incidentally, an SOC range of the all solid state battery obtained in Comparative Example 3 is determined at SOC of 20% to 80%.

### Comparative Example 4

An all solid state battery was obtained in the same manner as Example 2 except for forming an anode layer by using 6.5 mg of the anode layer forming material prepared in Comparative Example 2 in the production of the all solid state battery of Example 2.

Incidentally, an SOC range of the all solid state battery obtained in Comparative Example 4 is determined at SOC of 20% to 80%.

### Evaluations 3

### Capacity Maintenance Factor During High Rate

Next, with respect to the all solid state battery obtained in each of Example 2 and Comparative Example 3, constant-current charge was performed up to a voltage of 4.5 V or for 10 hours at a battery evaluation environmental temperature of 25° C. and a current rate of 0.1 C, and thereafter constant-current discharge was performed up to a voltage of 2.5 V at a current rate of 0.1 C. Next, constant-current charge was performed up to a voltage of 4.5 V or for 40 minutes at a current rate of 1.5 C, and thereafter constant-current discharge was performed up to a voltage of 2.5 V at a current rate of 1.5 C.

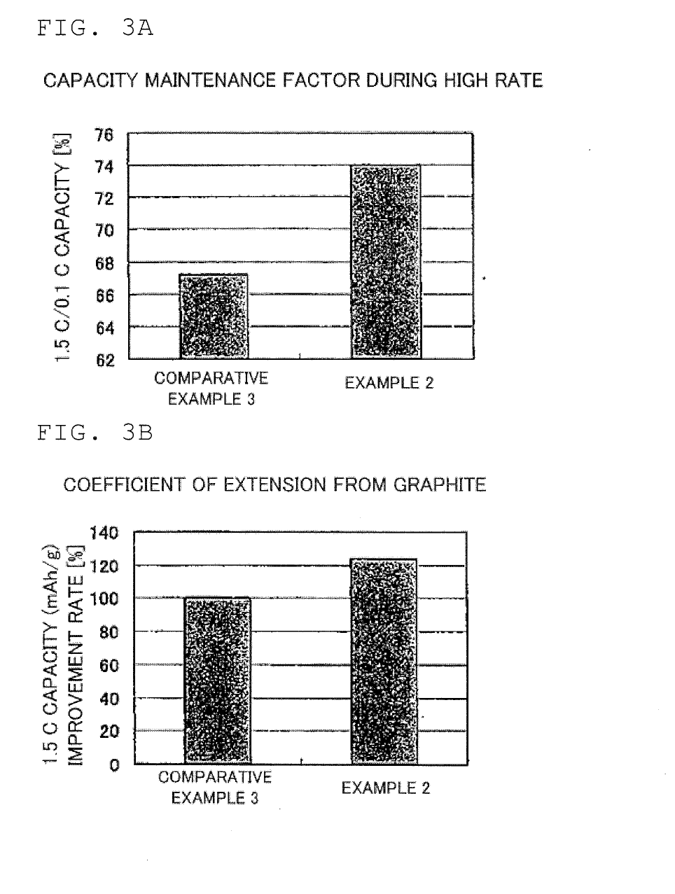

Capacity maintenance factor in charge and discharge during high rate was measured from the ratio of the discharge capacity in 1.5 C-discharge to the discharge capacity in 0.1 C-discharge. The results are shown in FIG. 3A. Also, the improvement rate of Example 2 to Comparative Example 3 in charge and discharge during high rate is shown in FIG. 3B. As shown in FIG. 3A, it is suggested that capacity maintenance factor improves in Example 2 as compared with Comparative Example 3. Also, FIG. 3B suggests that the capacity of Example 2 becomes 120% or more in the case where the capacity of Comparative Example 3 in charge and discharge during high rate is determined at 100%. That is to say, the use of the anode layer of Example 2 causes a lithium ion to be previously inserted into all of high-capacity Al, which is mixed so as to be in an SOC of 20% or less, at the initial stage of charge, and Al expands and the above-mentioned expanded state is maintained also in an SOC of 20% or more. Accordingly, it is conceived that the contact of graphite and the solid electrolyte material becomes so favorable as to improve input-output and cycling characteristics and thereby allow higher capacity maintenance factor than graphite singly.

### Evaluations 4

### Capacity Maintenance Factor Measurement Under Low External Restraint

In the all solid state battery obtained in each of Example 2 and Comparative Examples 3 and 4, charge and discharge were repeated at a battery evaluation environmental temperature of 60° C. and a current rate of 2 C and a voltage range of 3.5 V to 4.5 V while applying an external restraint force of 15 kgf/cm² until the number of charge and discharge becomes 10 times.

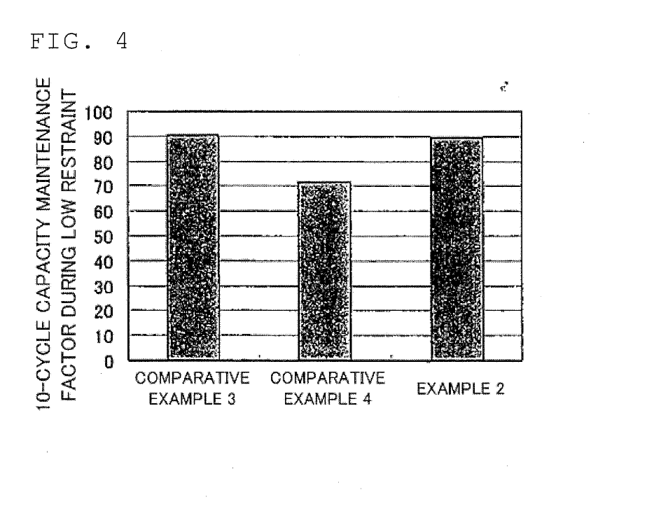

Capacity maintenance factor was measured after performing charge and discharge cycle ten times. The result is shown in FIG. 4.

As shown in FIG. 4, it was confirmed that Example 2 exhibited almost the same capacity maintenance factor as Comparative Example 3 and exhibited higher capacity maintenance factor than Comparative Example 4. In Comparative Example 4 using the anode layer of Al singly, the repetition of charge and discharge causes expansion and contraction of Al in volume, so that electrode peeling between particles and off the current collector is caused under low external restraint, and the capacity decreases after the cycle. On the other hand, Example 2 uses a mixture of Al and graphite, and the expanded state of Al is always maintained in SOC range even in repeating charge and discharge to bring a state of being restrained by self-restraining force in the anode layer. Thus, it is conceived that capacity maintenance factor after the cycle exhibits a value equivalent to graphite even under low external restraint.

### REFERENCE SIGNS LIST

1 . . . cathode layer
2 . . . anode layer
3 . . . solid electrolyte layer
4 . . . cathode current collector
5 . . . anode current collector
6 . . . battery case
7 . . . carbon-based active material
8 . . . metal-based active material
9 . . . sulfide solid electrolyte material
10 . . . all solid state battery
11 . . . anode active material

1-4. (canceled)

5. An all solid state battery comprising a cathode layer containing a cathode active material, an anode layer containing an anode active material, and a solid electrolyte layer formed between the cathode layer and the anode layer,
wherein the anode layer contains the anode active material such that a carbon-based active material and a metal-based active material are mixed,
the metal-based active material is a metal represented by a general formula M or a metal oxide represented by a general formula MₓO_{y} (M is a metal) for causing an alloying reaction with Li,
a charge and discharge potential of the metal-based active material is nobler than a charge and discharge potential of the carbon-based active material,
a capacity ratio of the carbon-based active material in the anode layer is higher than a capacity ratio of the metal-based active material, and
the capacity ratio of the metal-based active material in the anode layer is a lowest capacity ratio or less of a battery using range (an SOC range).

6. The all solid state battery according to claim 5, wherein the battery using range is determined at an SOC range of 20% or more, and the capacity ratio of the metal-based active material in the anode layer is within a range of 10% to 20%.
